(19) United States
(12) Patent Application Publication
(10) Pub. No.: US 2012/0232976 A1
(43) Pub. Date: Sep. 13, 2012

(54) REAL-TIME VIDEO ANALYSIS FOR REWARD OFFERS

(75) Inventors: Matthew A. Calman, Charlotte, NC (US); Erik Stephen Ross, Charlotte, NC (US); Alfred Hamilton, Charlotte, NC (US)

(73) Assignee: BANK OF AMERICA CORPORATION, Charlotte, NC (US)

(21) Appl. No.: 13/342,042

(22) Filed: Jan. 1, 2012

Related U.S. Application Data
(60) Provisional application No. 61/450,213, filed on Mar. 8, 2011.
(60) Provisional application No. 61/478,412, filed on Apr. 22, 2011.

(51) Int. Cl. G06Q 30/02

(52) U.S. Cl. 705/14.25; 705/14.4; 705/14.73

(57) ABSTRACT

Systems, methods, and computer program products are provided for using real-time video analysis, such as augmented reality or the like to assist the user of mobile devices with reward offers. Methods include recognizing one or more objects captured in a real-time video stream, where each object is associated with a marker; determining that the one or more objects are associated with a reward offer based on the marker; and presenting one or more indicators, each indicator being associated with the reward offer. In specific embodiments, the information associated with the object captured in the real-time video stream is analyzed based on financial data associated with a user.

This application claims priority to U.S. Provisional Patent Application Ser. No. 61/450,213, filed Mar. 8, 2011, entitled “Real-Time Video Image Analysis Applications for Commerce Activity,” and U.S. Provisional Application Ser. No. 61/478,412 filed on Apr. 22, 2011 and entitled “Real-Time Video Image Analysis for Reward Offers,” the entirety of each of which is incorporated herein by reference.

### BACKGROUND

Modern handheld mobile devices, such as smart phones or the like, combine multiple technologies to provide the user with a vast array of capabilities. For example, many smart phones are equipped with significant processing power, sophisticated multi-tasking operating systems, and high-bandwidth Internet connection capabilities. Moreover, such devices often have additional features that are becoming increasing more common and standardized features. Such features include, but are not limited to, location-determining devices, such as Global Positioning System (GPS) devices; sensor devices, such as accelerometers; and high-resolution video cameras.

As the hardware capabilities of such mobile devices have increased, so too have the applications (i.e., software) that rely on the hardware advances. One such example of innovative software is a category known as augmented reality (AR), or more generally referred to as mediated reality. One such example of an AR application platform is Layar, available from Layar, Amsterdam, the Netherlands.

The Layar platform technology analyzes location data, compass direction data, and the like in combination with information related to the objects, locations or the like in the video stream to create browse-able “hot-spots” or “tags” that are superimposed on the mobile device display, resulting in an experience described as “reality browsing.”

Many companies offer incentives or rewards associated with a particular product or service to their customers. For instance, some customers are given the opportunity to receive a reward when they use credit or debit cards. Information concerning the reward is often printed on the associated billing statement or sent via email. This dispersal of information is ineffective because the customer may miss the reward information contained in the billing statement or may filter out reward offer emails into a junk folder. Further, the customer may not have the reward offer information available at the time of purchase or when they are searching for a product or service.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, systems and computer program products are described herein that provide for using real-time video analysis and presentation, such as AR or the like to assist the user of mobile devices with a reward offer. Through the use of real-time vision, object recognition objects, logos, artwork, products, locations and other features that can be recognized in the real-time video stream can be matched to data associated with such to assist the user with one or more rewards offers. In specific embodiments, the data that is matched to the images in the real-time video stream is specific to financial institutions, such as customer financial behavior history, customer purchase power/transaction history and the like. In this regard, many of the embodiments herein disclosed leverage financial institution data, which is uniquely specific to a financial institution, in providing information to mobile device users in connection with real-time video stream analysis.

According to some embodiments, a method is provided for providing reward offer information in a real-time video stream, the method including: recognizing one or more objects captured in the real-time video stream, where each object is associated with a marker; determining that the one or more objects are associated with a reward offer based on the marker; and presenting one or more indicators, each indicator being associated with the reward offer.

In various other embodiments, a method includes receiving information from a user, where the information is associated with an object captured in a real-time video stream, the object being associated with a reward offer; and analyzing the information based on financial transaction data associated with the user.

In still other embodiments, a method is provides, the method including: receiving information from a user using the mobile device, where the information is associated with an object captured in a real-time video stream; analyzing the information based on financial transaction data associated with the user resulting in a reward offer; and communicating instructions to the mobile device to present the reward offer to the user.

In some embodiments, a computer program product is provided. The computer program product comprising a computer-readable medium having computer-executable instructions for performing: recognizing one or more objects captured in the real-time video stream, where each object is associated with a marker; determining that the one or more objects are associated with a reward offer based on the marker; and presenting one or more indicators, each indicator being associated with the reward offer.

A system for providing reward offer information in a real-time video stream is provided. The system comprising: a computer apparatus including a processor and a memory; and a reward offer software module stored in the memory, comprising executable instructions that when executed by the processor cause the processor to: recognize one or more objects captured in the real-time video stream, where each object is associated with a marker; determine that the one or more objects are associated with a reward offer based on the marker; and present one or more indicators, each indicator being associated with the reward offer.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile device, in accordance with an embodiment of the invention;

FIG. 2 is a block diagram illustrating an AR environment, in accordance with an embodiment of the invention;

FIG. 3 is a block diagram illustrating a mobile device, in accordance with an embodiment of the invention;

FIGS. 4A-4B are flowcharts illustrating a method for real-time video analysis, in accordance with an embodiment of the invention;

FIG. 5 is a flowchart illustrating another method for real-time video analysis, in accordance with an embodiment of the invention;

FIG. 6 is a front view of a mobile device, in accordance with an embodiment of the invention;

FIG. 7 is a front view of a mobile device, in accordance with an embodiment of the invention;

FIG. 8 is a front view of a mobile device, in accordance with an embodiment of the invention; and

FIG. 9 is a front view of a mobile device, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Thus, methods, systems, computer programs and the like are herein disclosed that provide for using real-time video analysis, such as AR or the like to assist the user of mobile devices with reward offers. The reward offer includes any offers associated with a financial transaction, purchase, loyalty program, membership, group, business, product, service, financial institution, account (e.g., a bank account, credit card account, store account, etc.), or activity. The reward associated with the reward offer includes points, loyalty program points, cash-back, contribution, gift cards, voucher, rebates, free products or services, free miles, free gas, free trials, balance transfers, upgrades of a product or service, favorable interest rates, etc. Through the use real-time vision object recognition, objects, logos, artwork, products, locations and other features that can be recognized in the real-time video stream can be matched to data associated with such to assist the user with reward offers. In specific embodiments, the data that is matched to the images in the real-time video stream is specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

While embodiments discussed herein are generally described with respect to “real-time video streams” or “real-time video” it will be appreciated that the video stream may be captured and stored for later viewing and analysis. Indeed, in some embodiments video is recorded and stored on a mobile device and portions or the entirety of the video may be analyzed at a later time. The later analysis may be conducted on the mobile device or loaded onto a different device for analysis. The portions of the video that may be stored and analyzed may range from a single frame of video (e.g., a screenshot) to the entirety of the video. Additionally, rather than video, the user may opt to take a still picture of the environment to be analyzed immediately or at a later time. Embodiments in which real-time video, recorded video or still pictures are analyzed are contemplated herein.

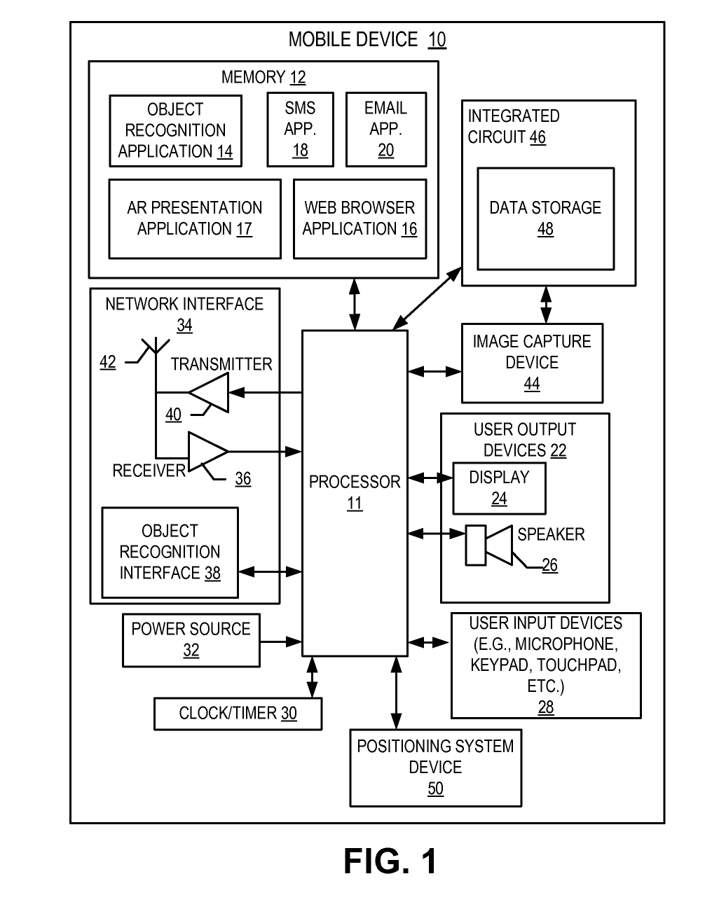

FIG. 1 illustrates an embodiment of a mobile device 10 that may be configured to execute object recognition and Augmented Reality (AR) functionality, in accordance with specific embodiments of the present invention. A “mobile device” 10 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 10 may generally include a processor 11 communicably coupled to such devices as a memory 12, user output devices 22, user input devices 28, a network interface 34, a power source 32, a clock or other timer 30, an image capture device 44, a positioning system device 50 (e.g., a Global Positioning System (GPS) device), one or more integrated circuits 46, etc.

In some embodiments, the mobile device and/or the server access one or more databases or data stores (not shown in FIG. 1) to search for and/or retrieve information related to the object and/or marker. In some embodiments, the mobile device and/or the server access one or more data stores local to the mobile device and/or server and in other embodiments, the mobile device and/or server access data stores remote to the mobile device and/or server. In some embodiments, the mobile device and/or server access both a memory and/or data store local to the mobile device and/or server as well as a data store remote from the mobile device and/or server

The processor 11, and other processors described herein, may generally include circuitry for implementing communication and/or logic functions of the mobile device 10. For example, the processor 11 may include a digital signal processor device, a microprocessor device, and various analog to digital converters, digital to analog converters, and/or other support circuits. Control and signal processing functions of the mobile device 10 may be allocated between these devices according to their respective capabilities. The processor 11 thus may also include the functionality to encode and interleave messages and data prior to modulation and transmission. The processor 11 may additionally include an internal data modem. Further, the processor 11 may include functionality to operate one or more software programs or applications, which may be stored in the memory 12. For example, the processor 11 may be capable of operating a connectivity program, such as a web browser application 16. The web browser application 16 may then allow the mobile device 10 to transmit and receive web content, such as, for example, location-based content and/or other web page content, according to a Wireless Application Protocol (WAP), Hypertext Transfer Protocol (HTTP), and/or the like.

The processor 11 may also be capable of operating applications, such as an object recognition application 14. The object recognition application 14 may be downloaded from a server and stored in the memory 12 of the mobile device 10. Alternatively, the object recognition application 14 may be pre-installed and stored in a memory in the integrated circuit 46. In such an embodiment, the user may not need to download the object recognition application 14 from a server. In some embodiments, the processor 11 may also be capable of operating one or more applications, such as one or more applications functioning as an artificial intelligence (“AI”) engine. The processor 11 may recognize objects that it has identified in prior uses by way of the AI engine. In this way, the processor 11 may recognize specific objects and/or classes of objects, and store information related to the recognized objects in one or more memories and/or databases discussed herein. Once the AI engine has thereby “learned” of an object and/or class of objects, the AI engine may run concurrently with and/or collaborate with other modules or applications described herein to perform the various steps of the methods discussed. For example, in some embodiments, the AI engine recognizes an object that has been recognized before and stored by the AI engine. The AI engine may then communicate to another application or module of the mobile device and/or server, an indication that the object may be the same object previously recognized. In this regard, the AI engine may provide a baseline or starting point from which to determine the nature of the object. In other embodiments, the AI engine's recognition of an object is accepted as the final recognition of the object.

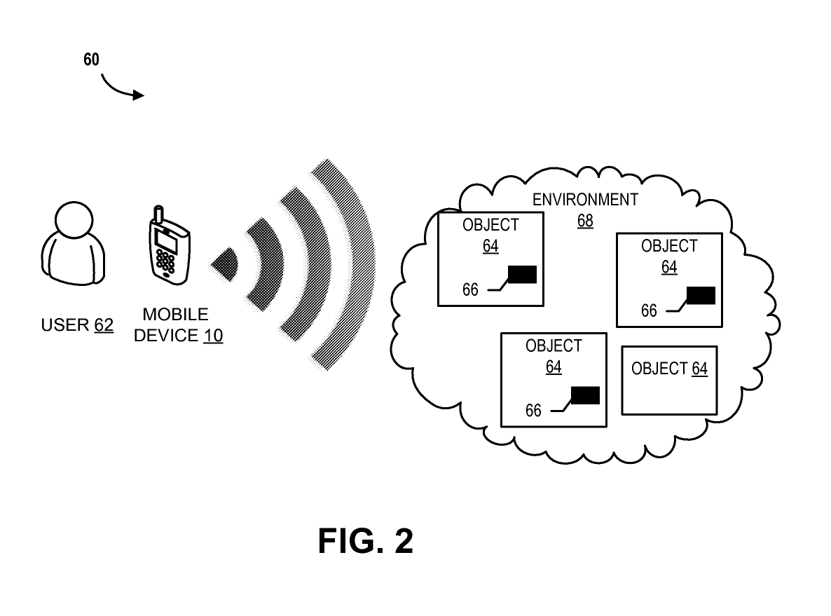

The integrated circuit 46 may include the necessary circuitry to provide the object recognition functionality to the mobile device 10. Generally, the integrated circuit 46 will include data storage 48 which may include data associated with the objects within a video stream that the object recognition application 14 identifies as having a certain marker(s) (discussed in relation to FIG. 2). The integrated circuit 46 and/or data storage 48 may be an integrated circuit, a microprocessor, a system-on-a-integrated circuit, a microcontroller, or the like. As discussed above, in one embodiment, the integrated circuit 46 may provide the functionality to the mobile device 10.

Of note, while FIG. 1 illustrates the integrated circuit 46 as a separate and distinct element within the mobile device 10, it will be apparent to those skilled in the art that the object recognition functionality of integrated circuit 46 may be incorporated within other elements in the mobile device 10. For instance, the functionality of the integrated circuit 46 may be incorporated within the mobile device memory 12 and/or processor 11. In a particular embodiment, the functionality of the integrated circuit 46 is incorporated in an element within the mobile device 10 that provides object recognition capabilities to the mobile device 10. Still further, the integrated circuit 46 functionality may be included in a removable storage device such as an SD card or the like.

The processor 11 may be configured to use the network interface 34 to communicate with one or more other devices on a network. In this regard, the network interface 34 may include an antenna 42 operatively coupled to a transmitter 40 and a receiver 36 (together a “transceiver”). The processor 11 may be configured to provide signals to and receive signals from the transmitter 40 and receiver 36, respectively. The signals may include signaling information in accordance with the air interface standard of the applicable cellular system of the wireless telephone network that may be part of the network. In this regard, the mobile device 10 may be configured to operate with one or more air interface standards, communication protocols, modulation types, and access types. By way of illustration, the mobile device 10 may be configured to operate in accordance with any of a number of first, second, third, and/or fourth-generation communication protocols and/or the like. For example, the mobile device 10 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 10 may also be configured to operate in accordance with non-cellular communication mechanisms, such as via a wireless local area network (WLAN) or other communication/data networks.

The network interface 34 may also include an object recognition interface 38 in order to allow a user to execute some or all of the above-described processes with respect to the object recognition application 14 and/or the integrated circuit 46. The object recognition interface 38 may have access to the hardware, e.g., the transceiver, and software previously described with respect to the network interface 34. Furthermore, the object recognition interface 38 may have the ability to connect to and communicate with an external data storage on a separate system within the network as a means of recognizing the object(s) in the video stream.

As described above, the mobile device 10 may have a user interface that includes user output devices 22 and/or user input devices 28. The user output devices 22 may include a display 24 (e.g., a liquid crystal display (LCD) or the like) and a speaker 26 or other audio device, which are operatively coupled to the processor 11. The user input devices 28, which may allow the mobile device 10 to receive data from a user, may include any of a number of devices allowing the mobile device 10 to receive data from a user, such as a keypad, keyboard, touch-screen, touchpad, microphone, mouse, joystick, other pointer device, button, soft key, and/or other input device(s).

The mobile device 10 may further include a power source 32. Generally, the power source 32 is a device that supplies electrical energy to an electrical load. In one embodiment, power source 32 may convert a form of energy such as solar energy, chemical energy, mechanical energy, etc. to electrical energy. Generally, the power source 32 in a mobile device 10 may be a battery, such as a lithium battery, a nickel-metal hydride battery, or the like, that is used for powering various circuits, e.g., the transceiver circuit, and other devices that are used to operate the mobile device 10. Alternatively, the power source 32 may be a power adapter that can connect a power supply from a power outlet to the mobile device 10. In such embodiments, a power adapter may be classified as a power source “in” the mobile device.

The mobile device 10 may also include a memory 12 operatively coupled to the processor 11. As used herein, memory may include any computer readable medium configured to store data, code, or other information. The memory 12 may include volatile memory, such as volatile Random Access Memory (RAM) including a cache area for the temporary storage of data. The memory 12 may also include non-volatile memory, which can be embedded and/or may be removable. The non-volatile memory may additionally or alternatively include an electrically erasable programmable read-only memory (EEPROM), flash memory or the like.

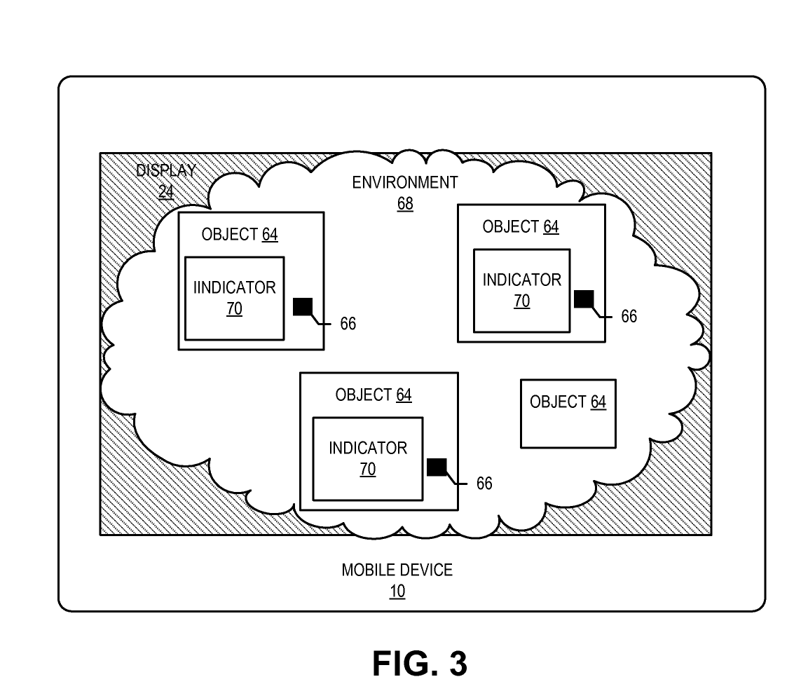

The memory 12 may store any of a number of applications or programs which comprise computer-executable instructions/code executed by the processor 11 to implement the functions of the mobile device 10 described herein. For example, the memory 12 may include such applications as an object recognition application 14, an augmented reality (AR) presentation application 17 (described infra. in relation to FIG. 3), a web browser application 16, a Short Message Service (SMS) application 18, an electronic mail (i.e., email) application 20, etc.

Referring to FIG. 2, a block diagram illustrating an object recognition experience 60 in which a user 62 utilizes a mobile device 10 to capture a video stream that includes an environment 68 is shown. As denoted earlier, the mobile device 10 may be any mobile communication device. The mobile device 10 has the capability of capturing a video stream of the surrounding environment 68. The video capture may be by any means known in the art. In one particular embodiment, the mobile device 10 is a mobile telephone equipped with an image capture device 44 capable of video capture.

The environment 68 contains a number of objects 64. Some of such objects 64 may include a marker 66 identifiable to an object recognition application that is either executed on the mobile device 10 or within the wireless network. A marker 66 may be any type of marker that is a distinguishing feature that can be interpreted by the object recognition application to identify specific objects 64. For instance, a marker 66 may be alpha-numeric characters, symbols, logos, shapes, ratio of size of one feature to another feature, a product identifying code such as a bar code, electromagnetic radiation such as radio waves (e.g., radio frequency identification (RFID)), architectural features, color, etc. In some embodiments, the marker 66 may be audio and the mobile device 10 may be capable of utilizing audio recognition to identify words or unique sounds broadcast. The marker 66 may be any size, shape, etc. Indeed, in some embodiments, the marker 66 may be very small relative to the object 64 such as the alpha-numeric characters that identify the name or model of an object 64, whereas, in other embodiments, the marker 66 is the entire object 64 such as the unique shape, size, structure, etc.

In some embodiments, the marker 66 is not actually a physical marker located on or being broadcast by the object 64. For instance, the marker 66 may be some type of identifiable feature that is an indication that the object 64 is nearby. In some embodiments, the marker 66 for an object 64 may actually be the marker 66 for a different object 64. For example, the mobile device 10 may recognize a particular building as being “Building A.” Data stored in the data storage 48 may indicate that “Building B” is located directly to the east and next to “Building A.” Thus, markers 66 for an object 64 that are not located on or being broadcast by the object 64 are generally based on fixed facts about the object 64 (e.g., “Building B” is next to “Building A”). However, it is not a requirement that such a marker 66 be such a fixed fact. The marker 66 may be anything that enables the mobile device 10 and associated applications to interpret to a desired confidence level what the object is. As another example, the mobile device 10, object recognition application 14 and/or AR presentation application 17 may be used to identify a particular person as a first character from a popular show, and thereafter utilize the information that the first character is nearby features of other characters to interpret that a second character, a third character, etc. are nearby, whereas without the identification of the first character, the features of the second and third characters may not have been used to identify the second and third characters. This example may also be applied to objects outside of people.

The marker 66 may also be, or include, social network data, such as data retrieved or communicated from the Internet, such as tweets, blog posts, social networking site posts, various types of messages and/or the like. In other embodiments, the marker 66 is provided in addition to social network data as mentioned above. For example, the mobile device 10 may capture a video stream and/or one or more still shots of a large gathering of people. In this example, as above, one or more people dressed as characters in costumes may be present at a specified location. The mobile device 10, object recognition application 14, and/or the AR presentation application 17 may identify several social network indicators, such as posts, blogs, tweets, messages, and/or the like indicating the presence of one or more of the characters at the specified location. In this way, the mobile device 10 and associated applications may communicate information regarding the social media communications to the user and/or use the information regarding the social media communications in conjunction with other methods of object recognition. For example, the mobile device 10 object recognition application 14, and/or the AR presentation application 17 performing recognition of the characters at the specified location may confirm that the characters being identified are in fact the correct characters based on the retrieved social media communications. This example may also be applied objects outside of people.

In some embodiments, the mobile device and/or server access one or more other servers, social media networks, applications and/or the like in order to retrieve and/or search for information useful in performing an object recognition. In some embodiments, the mobile device and/or server accesses another application by way of an application programming interface or API. In this regard, the mobile device and/or server may quickly search and/or retrieve information from the other program without requiring additional authentication steps or other gateway steps.

While FIG. 2 illustrates that the objects 64 with markers 66 only include a single marker 66, it will be appreciated that the object 64 may have any number of markers 66 with each equally capable of identifying the object 66. Similarly, multiple markers 66 may be identified by the mobile device 10 and associated applications such that the combination of the markers 66 may be utilized to identify the object 66. For example, the mobile device 10 may utilize facial recognition markers 66 to identify a person and/or utilize a separate marker 66, such as the clothes the person is wearing to confirm the identification to the desired confidence level that the person is in fact the person the mobile device identified. For example, the facial recognition may identify a person as a famous athlete, and thereafter utilize the uniform the person is wearing to confirm that it is in fact the famous athlete.

In some embodiments, a marker 66 may be the location of the object 64. In such embodiments, the mobile device 10 may utilize Global Positioning System (GPS) hardware and/or software or some other location determining mechanism to determine the location of the user 62 and/or object 64. As noted above, a location-based marker 66 could be utilized in conjunction with other non-location-based markers 66 identifiable and recognized by the mobile device 10 to identify the object 64. However, in some embodiments, a location-based marker may be the only marker 66. For instance, in such embodiments, the mobile device 10 may utilize GPS software to determine the location of the user 62 and a compass device or software to determine what direction the mobile device 10 is facing in order to identify the object 64. In still further embodiments, the mobile device 10 does not utilize any GPS data in the identification. In such embodiments, markers 66 utilized to identify the object 64 are not location-based.

FIG. 3 illustrates a mobile device 10, specifically the display 24 of the mobile 10, wherein the device 10 has executed an object recognition application 14 and an AR presentation application 17 to present within the display 24 indications of recognized objects within the live video stream (i.e., surrounding environment 68). The mobile device 10 is configured to rely on markers 66 to identify objects 64 that are associated with product offers, products with extended warranties, new products and the like, and indicate to the user 62 the identified objects 64 by displaying an indicator 70 on the mobile device display 24 in conjunction with display of the live video stream. As illustrated, if an object 64 does not have any markers 66 (or at least enough markers 66 to yield object identification), the object 64 will be displayed without an associated indicator 70.

The object recognition application 14 may use any type of means in order to identify desired objects 64. For instance, the object recognition application 14 may utilize one or more pattern recognition algorithms to analyze objects in the environment 68 and compare with markers 66 in data storage 48 which may be contained within the mobile device 10 (such as within integrated circuit 46) or externally on a separate system accessible via the connected network. For example, the pattern recognition algorithms may include decision trees, logistic regression, Bayes classifiers, support vector machines, kernel estimation, perceptrons, clustering algorithms, regression algorithms, categorical sequence labeling algorithms, real-valued sequence labeling algorithms, parsing algorithms, general algorithms for predicting arbitrarily-structured labels such as Bayesian networks and Markov random fields, ensemble learning algorithms such as bootstrap aggregating, boosting, ensemble averaging, combinations thereof, and the like.

Upon identifying an object 64 within the real-time video stream, the AR presentation application 17 is configured to superimpose an indicator 70 on the mobile device display 24. The indicator 70 is generally a graphical representation that highlights or outlines the object 64 and may be activatable (i.e., include an embedded link), such that the user 62 may “select” the indicator 70 and retrieve information related to the identified object. The information may include any desired information associated with the selected object and may range from basic information to greatly detailed information. In some embodiments, the indicator 70 may provide the user 62 with an internet hyperlink to further information on the object 64. The information may include, for example, all types of media, such as text, images, clipart, video clips, movies, or any other type of information desired. In yet other embodiments, the indicator 70 information related to the identified object may be visualized by the user 62 without “selecting” the indicator 70.

In embodiments in which the indicator 70 provides an interactive tab to the user 62, the user 62 may select the indicator 70 by any conventional means, e.g., keystroke, touch, voice command or the like, for interaction with the mobile device 10. For instance, in some embodiments, the user 62 may utilize an input device 28 such as a keyboard to highlight and select the indicator 70 in order to retrieve the information. In a particular embodiment, the mobile device display 24 includes a touch screen that the user may employ to select the indicator 70 utilizing the user's finger, a stylus, or the like.

In some embodiments, the indicator 70 is not interactive and simply provides information to the user 62 by superimposing the indicator 70 onto the display 24. For example, in some instances it may be beneficial for the AR presentation application 17 to merely identify an object 64, e.g., just identify the object's name/title, give brief information about the object, etc., rather than provide extensive detail that requires interaction with the indicator 70. The AR presentation application 17 is capable of being tailored to a user's desired preferences.

Furthermore, the indicator 70 may be displayed at any size on the mobile device display 24. The indicator 70 may be small enough that it is positioned on or next to the object 64 being identified such that the object 64 remains discernable behind the indicator 70. Additionally, the indicator 70 may be semi-transparent or an outline of the object 64, such that the object 64 remains discernable behind or enclosed by the indicator 70. In other embodiments, the indicator 70 may be large enough to completely cover the object 64 portrayed on the display 24. Indeed, in some embodiments, the indicator 70 may cover a majority or the entirety of the mobile device display 24.

The user 62 may opt to execute the object recognition application 14 and AR presentation application 17 at any desired moment and begin video capture and analysis. However, in some embodiments, the object recognition application 14 and AR presentation application 17 includes an “always on” feature in which the mobile device 10 is continuously capturing video and analyzing the objects 64 within the video stream. In such embodiments, the object recognition application 14 may be configured to alert the user 62 that a particular object 64 has been identified. The user 62 may set any number of user preferences to tailor the object recognition and AR presentation experience to their needs. For instance, the user 62 may opt to only be alerted if a certain particular object 64 is identified. Additionally, it will be appreciated that the “always on” feature in which video is continuously captured may consume the mobile device power source 32 more quickly. Thus, in some embodiments, the “always on” feature may disengage if a determined event occurs such as low power source 32, low levels of light for an extended period of time (e.g., such as if the mobile device 10 is in a user's pocket obstructing a clear view of the environment 68 from the mobile device 10), if the mobile device 10 remains stationary (thus receiving the same video stream) for an extended period of time, the user sets a certain time of day to disengage, etc. Conversely, if the “always on” feature is disengaged due to the occurrence of such an event, the user 62 may opt for the “always on” feature to re-engage after the duration of the disengaging event (e.g., power source 32 is re-charged, light levels are increased, etc.).

In some embodiments, the user 62 may identify objects 64 that the object recognition application 14 does not identify and add it to the data storage 48 with desired information in order to be identified and/or displayed in the future. For instance, the user 62 may select an unidentified object 64 and enter a name/title and/or any other desired information for the unidentified object 64. In such embodiments, the object recognition application 14 may detect/record certain markers 66 about the object so that the pattern recognition algorithm(s) (or other identification means) may detect the object 64 in the future. Furthermore, in cases where the object information is within the data storage 48, but the object recognition application 14 fails to identify the object 64 (e.g., one or more identifying characteristics or markers 66 of the object has changed since it was added to the data storage 48 or the marker 66 simply was not identified), the user 62 may select the object 64 and associate it with an object 64 already stored in the data storage 48. In such cases, the object recognition application 14 may be capable of updating the markers 66 for the object 64 in order to identify the object in future video streams.

In addition, in some embodiments, the user 62 may opt to edit the information or add to the information provided by the indicator 70. For instance, the user 62 may opt to include user-specific information about a certain object 64 such that the information may be displayed upon a future identification of the object 64. Conversely, in some embodiments, the user may opt to delete or hide an object 64 from being identified and an indicator 70 associated therewith being displayed on the mobile device display 24.

Furthermore, in some instances, an object 64 may include one or more markers 66 identified by the object recognition application 14 that leads the object recognition application 14 to associate an object with more than one objects in the data storage 48. In such instances, the user 62 may be presented with multiple candidate identifications and may opt to choose the appropriate identification or input a different identification. The multiple candidates may be presented to the user 62 by any means. For instance, in one embodiment, the candidates are presented to the user 62 as a list wherein the “strongest” candidate is listed first based on reliability of the identification. Upon input by the user 62 identifying the object 64, the object recognition application 14 may “learn” from the input and store additional markers 66 in order to avoid multiple identification candidates for the same object 64 in future identifications.

Additionally, the object recognition application 14 may utilize other metrics for identification than identification algorithms. For instance, the object recognition application 14 may utilize the user's location, time of day, season, weather, speed of location changes (e.g., walking versus traveling), “busyness” (e.g., how many objects are in motion versus stationary in the video stream), as well any number of other conceivable factors in determining the identification of objects 64. Moreover, the user 62 may input preferences or other metrics for which the object recognition application 14 may utilize to narrow results of identified objects 64.

In some embodiments, the AR presentation application 17 may have the ability to gather and report user interactions with displayed indicators 70. The data elements gathered and reported may include, but are not limited to, number of offer impressions; time spent “viewing” an offer, product, object or business; number of offers investigated via a selection; number of offers loaded to an electronic wallet and the like. Such user interactions may be reported to any type of entity desired. In one particular embodiment, the user interactions may be reported to a financial institution and the information reported may include customer financial behavior, purchase power/transaction history, and the like.

In various embodiments, information associated with or related to one or more objects that is retrieved for presentation to a user via the mobile device may be permanently or semi-permanently associated with the object. In other words, the object may be “tagged” with the information. In some embodiments, a location pointer is associated with an object after information is retrieved regarding the object. In this regard, subsequent mobile devices capturing the object for recognition may retrieve the associated information, tags and/or pointers in order to more quickly retrieve information regarding the object. In some embodiments, the mobile device provides the user an opportunity to post messages, links to information or the like and associate such postings with the object. Subsequent users may then be presenting such postings when their mobile devices capture and recognize an object. In some embodiments, the information gathered through the recognition and information retrieval process may be posted by the user in association with the object. Such tags and/or postings may be stored in a predetermined memory and/or database for ease of searching and retrieval.

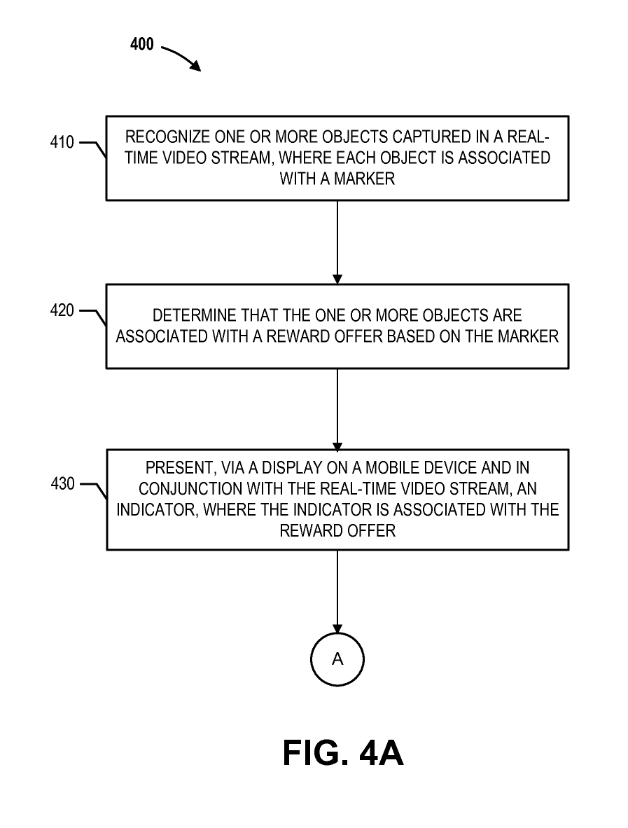

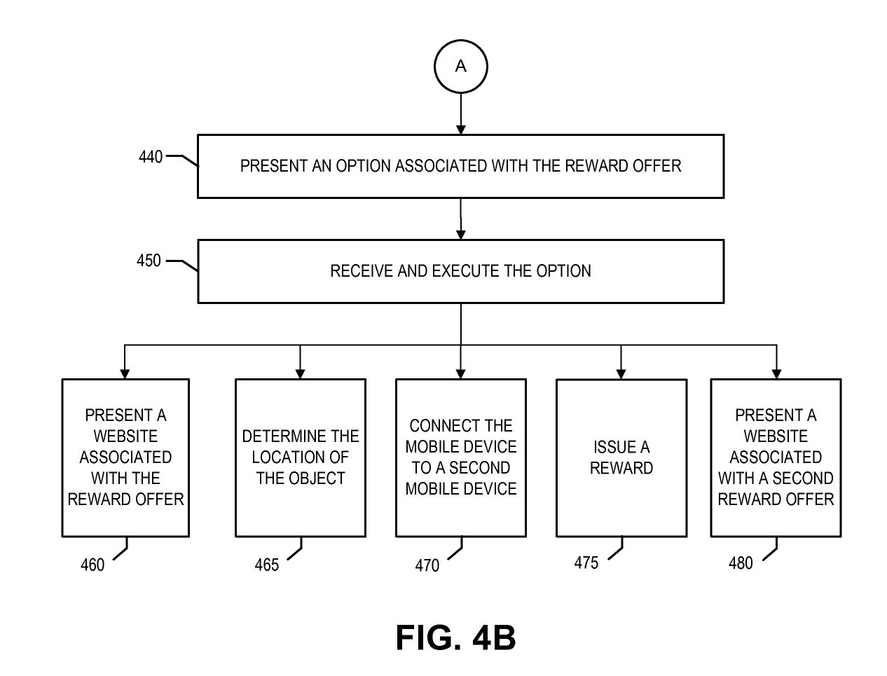

FIGS. 4A-4B illustrate flowcharts of a method 400 for analyzing real-time video stream according to embodiments of the invention. It will be understood that one or more devices can be configured to perform one or more steps of the method 400. In block 410, one or more objects captured in a real-time video stream are recognized. In some embodiments, each object is associated with a marker. In some embodiments, the mobile device (e.g., the mobile device 10) is configured to capture real-time video stream, including one or more screen shots, stills, or the like. In addition to capturing visual views or images of objects in an environment, the real-time video stream may also include auditory elements, sounds, or the like associated with the environment being captured. For example, the mobile device may capture product images sold in a store and also a jingle, voice recording, or announcements projected over the intercom in that store. In some embodiments, the mobile device is configured to send data associated with the video stream to one or more servers for analyzing. In one embodiment, for example, the server is configured to identify the object and/or marker, retrieve information related to the object and/or marker, and send that information or a link to that information to the mobile device. In some embodiments, the server is associated with a financial institution and, for example, owned and managed by the financial institution.

In some embodiments, the mobile device and/or the server access one or more databases or datastores (not shown) to search for and/or retrieve information related to the object and/or marker. In some embodiments, the mobile device and/or the server access one or more datastores local to the mobile device and/or server and in other embodiments, the mobile device and/or server access datastores remote to the mobile device and/or server. In some embodiments, the mobile device and/or server access both a memory and/or datastore local to the mobile device and/or server as well as a datastore remote from the mobile device and/or server.

In block 420, a determination is made that the one or more objects are associated with a reward offer based on the marker. The marker includes any data that identifies the object as being associated with the reward offer such as a logo; a product identification number; a sound associated with a product, service, or business; user information; television or radio commercial characters; spokespersons; cartoon characters; and the like. For example, the marker may be a product identification number that is associated with a rebate offer, or a feature that identifies a product as being associated with a cash back offer for a credit card. In an exemplary embodiment, one marker identifies the object and a second marker identifies the object as being associated with a reward offer. In other embodiments, the marker identifies the object and the reward offer associated with the object.

In various embodiments, the mobile device and/or a remote server perform the step associated with block 420. For example, in some embodiments, the mobile device communicates via a network with a server a request to return information regarding the one or more objects. Specifically, the communication may request information regarding whether the one or more objects and/or one or more markers are associated with one or more rewards offers. In some embodiments, the mobile device and/or the server sends the request across the network to a database or datastore, and the database or datastore returns information responding to the request. For example, the datastore may return a listing of rewards offers associated with the object and/or marker.

In block 430, an indicator associated with the reward offer is presented via a display on a mobile device and in conjunction with the real-time video stream. Reward offers may be current rewards, previous reward offers that have been obtained by the user (a historical view), friends reward offers, social networking rewards offers, etc. The indicator includes any visual, auditory, tactile, or other perceivable clue that alerts the user of the reward offer. Further, the indicator includes a virtual image (e.g., the virtual image 300), vibration, lighted display, lighted key pad, flash of light, beep, ring tone, text message, email, voice message, and the like, or any combination of one or more of the indicators listed above.

In various embodiments, the presentation is not performed in conjunction with a real-time video stream, but rather, the presentation is performed by itself. For example, in some embodiments, the presentation includes information regarding one or more rewards offers associated with one or more objects and/or markers as discussed further below. In one embodiment, for example, an object is recognized as associated with a rewards offer, an indicator is presented in a real-time video stream, and the user is provided an opportunity to select the object, such as by touching the presentation of the object on a touch screen configured for receiving user input via touch. The mobile device then retrieves information regarding the rewards program associated with the object.

Referring now to FIG. 4B, the method 400 is further illustrated. In various embodiments, one or more of the steps of FIGS. 4A and/or 4B may be optional steps and therefore, may or may not be implemented. In block 440, an option associated with the reward offer is presented. The option includes choices associated with the reward offer, the object, and/or the environment associated with the object. In some embodiments, the user “selects” the indicator, such as the virtual image 300 to access the option. In other embodiments, the option is presented simultaneously or shortly after the indicator is presented. The option include a choice, a user input field, a link to a website, and the like. For example, upon presentation of the indicator, the user, via a mobile device display, may be presented with a set of options such as “continue,” “remind me later,” or “no.” Upon selection of the “continue” or “remind me later” option, the user may be presented with another set of options. In another example, the user may automatically receive a text message, voice mail, or email relaying further information about the reward upon selection of the remind me later option.

In block 450, the option is received and executed. In some embodiments, the option is received and executed by a processor (e.g., processor 110, or other processor) immediately after presentation of the option. In other embodiments, the reception and execution of the option is delayed by the user, a mobile device processor, or server processor.

In block 460, a website associated with the reward offer is presented. The website may include a link, web page, or graphical user interface operated by the business associated with the reward offer or a third party. The website can include websites associated with a financial institution, business, social network, blog, government entity, and the like. In block 465, the location of the object is determined. As discussed above, in various embodiments the location may be determined using GPS technology, and in some embodiments, the location may be determined based in whole or in part on recognition of other nearby distinctive objects, such as, for example, a building having a unique architecture. In some embodiments, the mobile device is configured to determine directions to the location of the object. In other embodiments, text or images related to the location are presented. For example, a set of directions and/or a map indicating the location of the object or the location of similar objects is presented on the mobile device display. In block 470, a second mobile device is connected to the mobile device. For example, the mobile device may be configured to connect to a second mobile device via a blue tooth connection, near field communication connection, RF connection, and the like. The second mobile device may include a navigation system, a mobile phone, a smart phone, a computer, and the like.

In block 475, a reward is issued. In some embodiments, the mobile device is configured to receive the reward and issue the reward to the user. In some embodiments, a reward issuer is in communication with the mobile device. For example, a smart phone service provider may offer the user a free phone “app” or free texts in exchange for an extended contract, and the service provide may authorize the mobile device to provide free texts and phone app to the user. As another example, the mobile device may be configured to send a message containing a promotional code for free shipping to the user for use in purchasing products online. The user, for example, may access the reward by clicking on the virtual image 300 to receive the promotional code for free shipping. In other embodiments, rewards may be linked to a wish list or bundled with a corresponding offer. In this way, the user may be offered rewards relating to products that the user provides on a wish list of products the user expects to purchase in the future.

In block 480, a website associated with a second reward offer is presented. For example, the mobile device or associated server can be configured to determine other reward offers. The second reward offer includes offers similar or related to the reward offer, an offer specific to the user, new reward offers, a previously undetermined reward offer and the like. In some embodiments, the website associated with the second reward offer is specific to a particular product and/or business. For example, if the object associated with the reward offer is a sports car from Dealer A, the mobile device is configured to locate reward offers associated with the same or different car from Dealer B. In other embodiments, the website associated with the second reward offer is associated with a particular location. For example, the mobile device may be configured to determine all or some of the reward offers available to the user within a five mile radius of the user's current location.

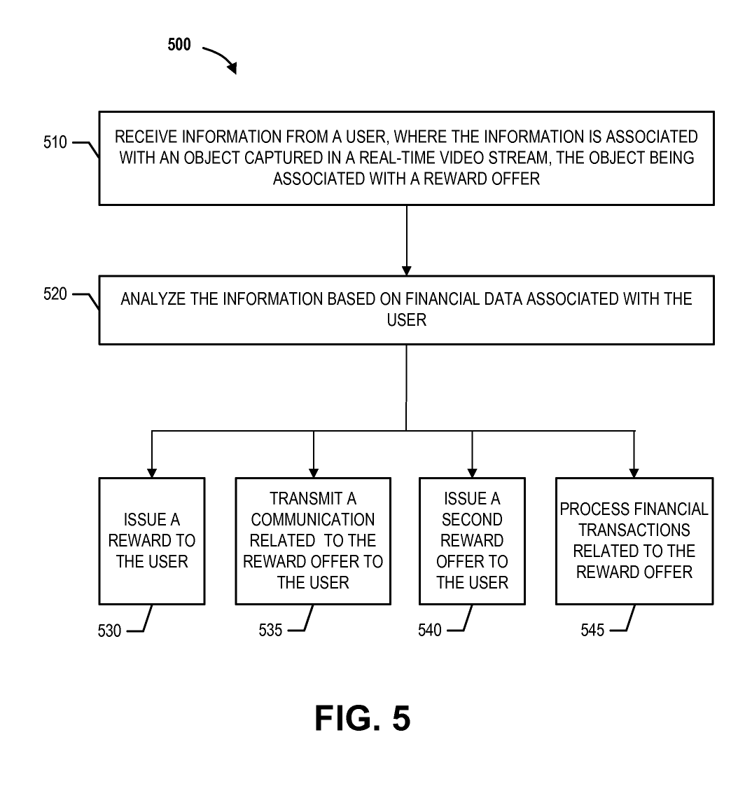

FIG. 5 illustrates a flowchart of a method 500 for analyzing a real-time video stream according to embodiments of the invention. It will be understood that one or more devices, such as one or more mobile device and/or one or more other computing devices and/or servers, can be configured to perform one or more steps of the method 500. In some embodiments, the one or more devices performing the steps are associated with a financial institution. In other embodiments, the one or more devices performing the steps are associated with a business or third party associated with the object, reward offer, and/or user. In block 510, information from a user is received, where the information is associated with an object captured in a real-time video stream, the object being associated with a reward offer. The object and reward are described in detail with reference to FIGS. 2-4B above. The information includes the marker, a view of the object, user information, the location of the mobile device capturing the video stream, mobile device identification, and/or any other information associated with the object. For example, a server associated with a financial institution may be configured to receive the information and determine the identification of the user and the identification of the object. The information may be directly or indirectly received from the user. For example, the one or more devices receiving the information may be in direct communication with the mobile device of the user, or the devices may receive the information from a third party source.

In block 520, the information is analyzed based on financial data associated with the user. In some embodiments, the user provides the financial data. For example, the user may provide purchase price, the business where the purchase was made, product information, payment method, and the like to a financial institution or business. In other embodiments, a business provides the financial information. In still other embodiments, a third party provides the financial data. The financial data may include, in various embodiments, purchase transaction information, sales information, purchase amounts, purchase dates, account information, accumulated points, interest rates, card numbers, check numbers, and the like.

In some embodiments, the information is analyzed based on the financial transaction data associated with the user resulting in a reward offer. For example, a server associated with a financial institution may determine that the object is associated with a reward offer based on the identity of the object and the financial transaction data associated with the user. In this case, the object may not have a reward offer associated with it, or the server may determine that a previously unidentified second reward offer is associated with the object based on the financial transaction data associated with the user. In other embodiments, instructions are communicated to the mobile device to present the reward offer to the user. For example, the mobile device is configured to present the virtual image 300 to indicate that the object is associated with a reward offer as detailed above with regard to FIGS. 2-3.

In some embodiments, the information provided by the real-time video stream may be compared to data provided to the system through an API. In this way, the data may be stored in a separate API and be implemented by request from the mobile device and/or server accesses another application by way of an API.

In block 530, the reward is issued to the user. In some embodiments, the reward is issued by the reward issuer. The reward issuer includes any entity that is authorized to issue the reward, such as a financial institution, a business, a group, a website operator, a third party, and the like. The reward may be issued by mail, text message, email, automatic account deposit, check, a credit deposit, or any other electronic or non-electronic means. The reward may be issued at the time the reward offer is fulfilled or a short time afterward. For example, the reward may be automatically issued upon reaching a specific credit limit, time period or date, a purchase amount, number of transactions, and the like. In some embodiments, the reward is issued to a user account associated with the reward offer. For example, a server associated with a financial institution may automatically update the number of reward points associated with the user's credit card account every month. In other embodiments, the user determines when the reward is issued. For example, a user may choose to receive a cash-back check in the mail on a bi-monthly basis or only once a year. In still other embodiments, the user determines the type of reward to be issued. For example, the user may choose to receive cash-back rather than loyalty points.

In block 535, a communication related to the reward offer is transmitted to the user. The communication includes the time period of the reward offer, the terms of the reward offer, related reward offers, businesses associated with reward offer, products or services related to the reward offer, reward information, rewards accumulated over a period of time, and the like. The user can be transmitted electronically, by mail, through a user account, advertisement, email, text message, voice message, and the like. In some embodiments, the user determines when, how, and what information is to be included in the communication. For example, a user can limit the communication to text messages that indicate how many points have been earned in the past year.

In block 540, a second reward offer is issued to the user. The second reward offer includes reward offers that are related or unrelated to the reward offer associated with the object, reward offers associated with various businesses, and the like. In some embodiments, the reward offer can be issued in conjunction with a coupon or discount. In other embodiments, a second reward offer is issued to the user. In some embodiments, a reward that is unrelated to the reward offer associated with the object, or a previously unidentified reward can be issued to the user. For example, a credit card user may reach a certain credit purchase amount by purchasing the object and fulfill a second reward offer, but not earn enough credits to fulfill the identified reward offer associated with the object.

In block 545, financial transactions related to the reward offer are processed. The financial transaction may be or include, in various embodiments, an online purchase, a purchase using the mobile device, a purchase made using a point of sales device, a credit or debit card purchase, a cash purchase, a purchase made using a check, an ATM withdrawal, an account withdrawal, account maintenance, moving money between accounts, online banking transactions including purchases, and the like. For example, a device or server associated with a financial institution may be configured to authorize the issuing of a cash back reward, purchasing of the object, or any other financial transaction. As another example, a financial institution providing the reward offer, may authorize the user to make an online purchase using a credit card or move money over to a checking account in order to purchase the object. The financial institution may also receive and process the purchase information from the business from which the object was purchased and issue the reward.

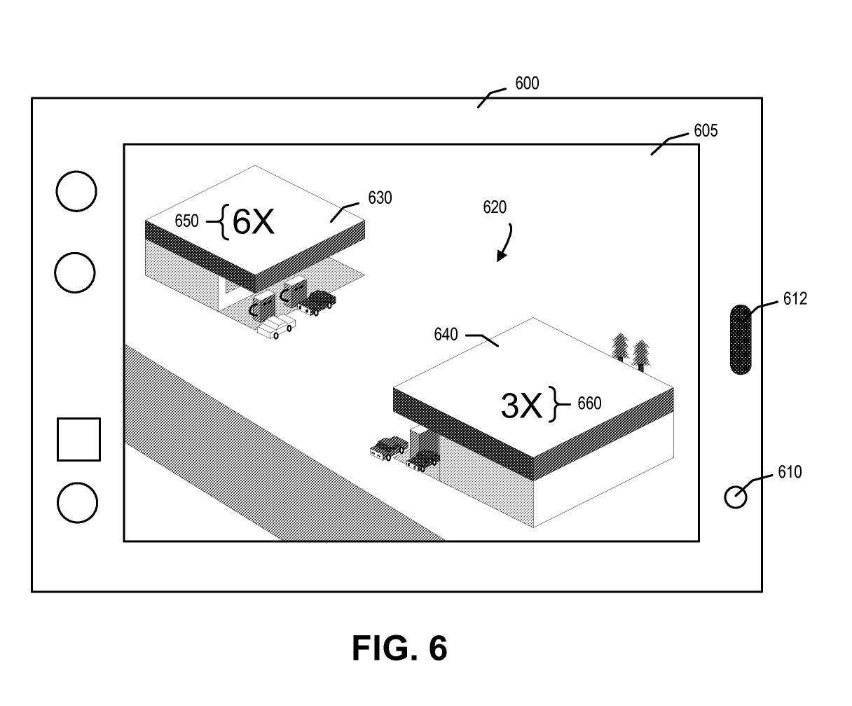

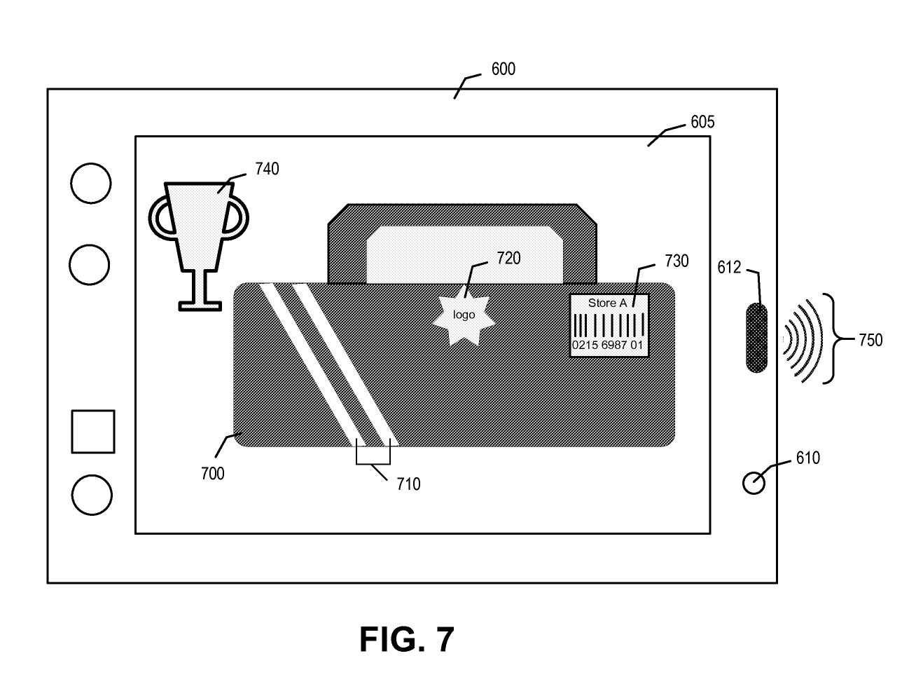

FIGS. 6-7 illustrate a mobile device utilized to capture a real-time video stream in accordance with embodiments. As shown in FIG. 6, handheld device 600 (e.g., a smart phone) includes a display 605, a camera 610, a speaker 612, and a microphone (not shown). Although a particular arrangement of the handheld device 600 is shown, the speaker 612, the camera 610, and the display 605 may be arranged in any manner in various embodiments. For example, in some embodiments, the handheld device 600 includes a camera positioned on the back side of the handheld device 600. The camera 610 and microphone can be used to capture an environment 620 in a real-time video stream. The environment 620 can include any of the surroundings that the handheld device 600 is capable of capturing, such as a road, a space, a city, a store, or any other viewable area or auditory sounds associated with the environment. It will be understood that the hand held device 600 can be positioned anywhere. The handheld 600 device may be, for example, installed in an automobile and projected on the windshield. In the exemplary embodiment, the environment 620 includes a road and a first gas station 630 and a second gas station 640. It will be understood that the objects described above with regard to FIGS. 1-5, may include the first and second gas stations 630, 640. The gas stations 630, 640 can be identified by any number of markers such as geographic coordinates, a mile marker, any signs, advertisements, or logos associated with the gas stations 630, 640, and the like. Also shown on the display 605 are virtual image indicators 650, 660. The indicators 650, 660 include information relating to a reward offer. Indicator 650 is labeled as “6X” and demonstrates that six points can be earned by purchasing gas at gas station 630 and the indicator 660 labeled “3X” demonstrates that only three points may be earned at gas station 640. In this way, the user can determine the optimal place to purchase gas in order to maximize reward earnings.

Comparative indicators may also be used to compare different products. In some embodiments, for example, a “5X” virtual image may be superimposed on a well-known brand of cereal, while a “1X” virtual image may be superimposed on a store brand of cereal. In this way, the user can determine that the well-known brand of cereal may be cheaper than the store brand when the reward offer is considered or in other embodiments, the well-known brand of cereal may be more expensive than the store brand, but the comparatively higher rewards, such as rewards or loyalty points may entice a customer to spend the extra money necessary to purchase the well-known brand of cereal rather than the store brand despite the higher price of the well-known brand. Other indicators that can be used include dollar signs, animated icons, mascots, personalized icons, and the like. The indicator can also include other details about the reward offer such as the expiration date of the reward offer, the type of reward associated with the reward offer, total earn rewards, and the like.

The indicators 650, 640 may also be used to indicate that objects within the gas stations 630, 640 or other businesses are associated with reward offers. For example, markers such as an advertisement placed outside of the gas stations 630, 640 (e.g., on a window) may indicate that there are objects within the store that are associated with a reward offer. Thus, when a mobile device recognizes the marker located on the outside of the business, the user is presented with an indicator communicating one or more reward offers associated with the purchase of one or more products and/or services sold by the business.

Referring now to FIG. 7, an object or purse 700 is captured in a real-time video stream using the camera 610 and is presented on the display 605. Information and reward offers associated with the purse 700 can be determined by the overall shape of the purse. The purse 700 includes markers 710, 720, and 730, where each marker can be used alone or in conjunction with one or more other markers to determine the identity of the object and any reward offer associated with the purse 700. The markers 710 are unique stripes that indicate that the purse is associated with a particular purse style or a particular brand. The marker 720 is the brand logo associated with the purse 700. The marker 720 can identify the purse 700 by the overall shape of the logo or the text written on the logo. Marker 730 is a store label comprising the store name as well as a bar code and associated product code. Each marker may be used to determine the same or different information about the purse 700 and/or reward offer. For example, the store label marker 730 may be used to determine reward offers associated with Store A, while logo marker 720 may be used to determine the type of reward associated with the purse 700, while stripe marker 710 may be used to identify the model of the purse 700.

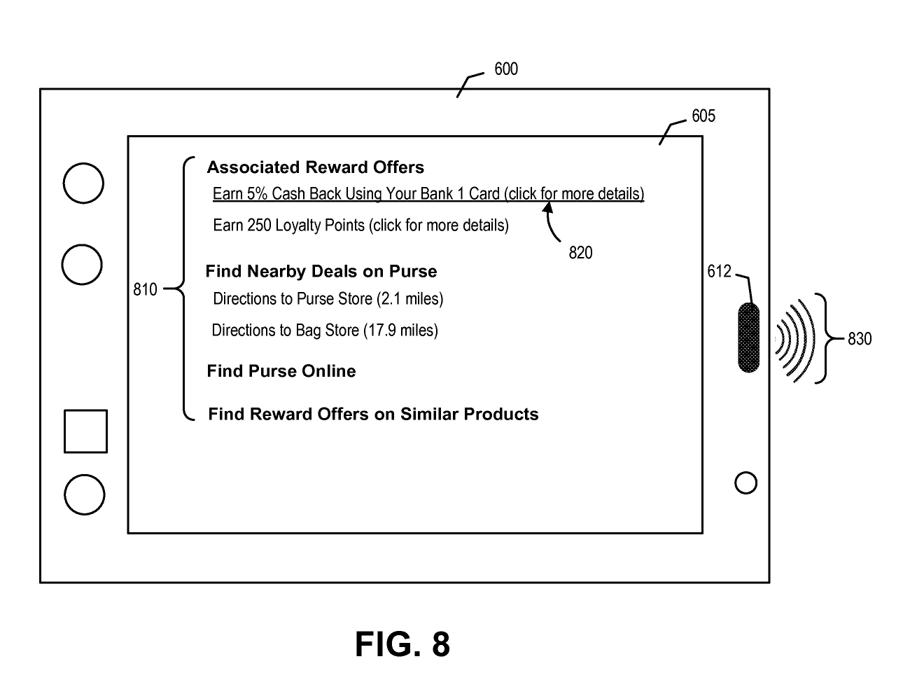

Also included in the display 605, as shown in FIG. 7, is a virtual image award cup icon indicator 740. Also shown is audio indicator 750 that is emitted from speaker 612. The audio indicator 750 can include a voice message that provides basic or detailed information about the reward offer, a beep, a ring tone, or the like. In addition, the handheld device 600 may also vibrate to indicate that the purse 700 is associated with the reward offer. The user can select the indicator 740 by clicking on the icon in order to view more information about the reward offer as shown in FIG. 8.

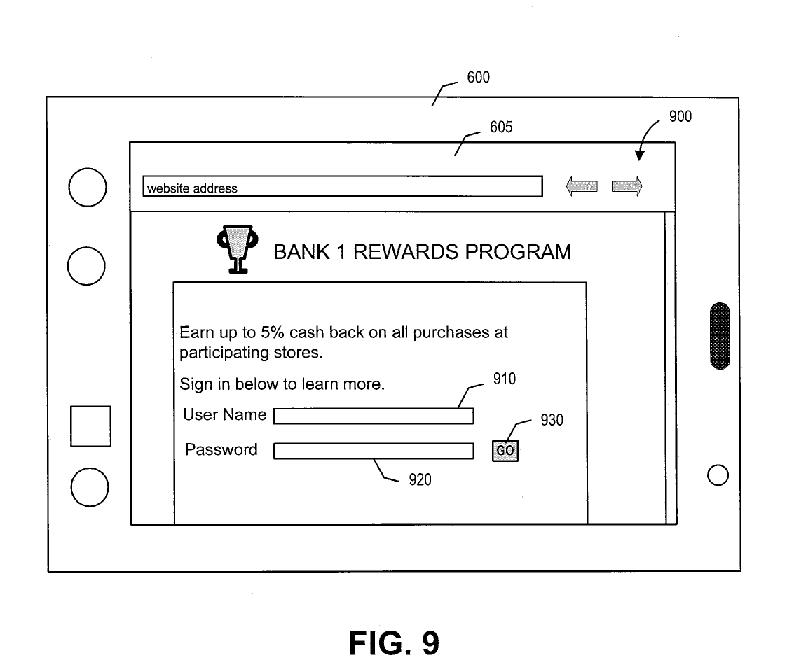

FIG. 8 illustrates options associated with a reward offer presented on the display 605 of the handheld device 600. Upon clicking the icon indicator 740, the user is presented with a plurality of options 810. The options 810 include options for determining reward offers that are associated with the purse 700, nearby purse deals, online purses, and reward offers on similar products. Voice recording 830 is emitted from speaker 612 and enables the user to hear the options 810 rather than viewing them. The voice recording 830 is especially helpful when the user is unable or unwilling to view the display. The user can click on any link in order to view a website or other options. In the illustrated embodiment, the “Earn 5% Cash Back” link is selected and the resulting presentation on the display 605 is shown in FIG. 9.

In FIG. 9, graphical user interface (GUI) 900 is presented in the display 605. GUI 900 is associated with the reward offer issuer, which is a financial institution named “Bank 1.” The user can input a user name in field 910 and password in field 920 and select the “Go” button 930 to access a bank account and determine specific information about the reward offer. The GUI 900 may be presented automatically or once the user has selected an indicator associated with an object or marker, or may be presented automatically when other details regarding a rewards offer is presented to the user.

The systems, methods, computer program products, etc. described herein, may be utilized or combined with any other suitable AR-related application. Non-limiting examples of other suitable AR-related applications include those described in the following U.S. Provisional Patent Applications, the entirety of each of which is incorporated herein by reference:

| U.S. | | |
|---|---|---|
| Provisional | | |
| Ser. | | |
| No. | Filed On | Title |
| 61/450,213 | Mar. 8, 2011 | Real-Time Video Image Analysis |
| | | Applications for Commerce Activity |
| 61/478,409 | Apr. 22, 2011 | Presenting Offers on a Mobile |
| | | Communication Device |
| 61/478,394 | Apr. 22, 2011 | Real-Time Video Image Analysis for |
| | | Providing Targeted Offers |
| 61/478,399 | Apr. 22, 2011 | Real-Time Analysis Involving Real |
| | | Estate Listings |
| 61/478,402 | Apr. 22, 2011 | Real-Time Video Image Analysis for an |
| | | Appropriate Payment Account |
| 61/478,405 | Apr. 22, 2011 | Presenting Investment-Related |
| | | Information on a Mobile Communication |
| | | Device |
| 61/478,393 | Apr. 22, 2011 | Real-Time Image Analysis for Medical |
| | | Savings Plans |
| 61/478,397 | Apr. 22, 2011 | Providing Data Associated With |
| | | Relationships Between Individuals and |
| | | Images |
| 61/478,408 | Apr. 22, 2011 | Identifying Predetermined Objects in a |
| | | Video Stream Captured by a Mobile |
| | | Device |
| 61/478,400 | Apr. 22, 2011 | Real-Time Image Analysis for Providing |
| | | Health Related Information |
| 61/478,411 | Apr. 22, 2011 | Retrieving Product Information From |
| | | Embedded Sensors Via Mobile Device |
| | | Video Analysis |
| 61/478,403 | Apr. 22, 2011 | Providing Social Impact Information |
| | | Associated With Identified Products or |
| | | Businesses |
| 61/478,407 | Apr. 22, 2011 | Providing Information Associated With |
| | | an Identified Representation of an Object |
| 61/478,415 | Apr. 22, 2011 | Providing Location Identification of |
| | | Associated Individuals Based on |
| | | Identifying the Individuals in |
| | | Conjunction With a Live Video Stream |
| 61/478,419 | Apr. 22, 2011 | Vehicle Recognition |
| 61/478,417 | Apr. 22, 2011 | Collective Network of Augmented |
| | | Reality Users |
| 61/508,985 | Jul. 18, 2011 | Providing Information Regarding |
| | | Medical Conditions |
| 61/508,946 | Jul. 18, 2011 | Dynamically Identifying Individuals |
| | | From a Captured Image |
| 61/508,980 | Jul. 18, 2011 | Providing Affinity Program Information |
| 61/508,821 | Jul. 18, 2011 | Providing Information Regarding Sports |
| | | Movements |
| 61/508,850 | Jul. 18, 2011 | Assessing Environmental Characteristics |
| | | in a Video Stream Captured by a Mobile |
| | | Device |
| 61/508,966 | Jul. 18, 2011 | Real-Time Video Image Analysis for |
| | | Providing Virtual Landscaping |
| 61/508,969 | Jul. 18, 2011 | Real-Time Video Image Analysis for |
| | | Providing Virtual Interior Design |
| 61/508,971 | Jul. 18, 2011 | Real-Time Video Image Analysis for |
| | | Providing Deepening Customer Value |
| 61/508,764 | Jul. 18, 2011 | Conducting Financial Transactions Based |
| | | on Identification of Individuals in an |
| | | Augmented Reality Environment |
| 61/508,973 | Jul. 18, 2011 | Real-Time Video Image Analysis for |
| | | Providing Security |
| 61/508,976 | Jul. 18, 2011 | Providing Retail Shopping Assistance |
| 61/508,944 | Jul. 18, 2011 | Recognizing Financial Document Images |

Thus, methods, systems, computer programs and the like have been disclosed that provide for using real-time video analysis, such as AR or the like to assist the user of mobile devices with commerce activities. Through the use real-time vision object recognition objects, logos, artwork, products, locations and other features that can be recognized in the real-time video stream can be matched to data associated with such to assist the user with commerce activity. The commerce activity may include, but is not limited to; conducting a transaction, providing information about a product/service, providing rewards based information, providing user-specific offers, or the like. In specific embodiments, the data that matched to the images in the real-time video stream is specific to financial institutions, such as customer financial behavior history, customer purchase power/transaction history and the like. In this regard, many of the embodiments herein disclosed leverage financial institution data, which is uniquely specific to financial institution, in providing information to mobile devices users in connection with real-time video stream analysis.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing reward offer information in a real-time video stream, the method comprising:
recognizing one or more objects captured in the real-time video stream via a computer device processor, wherein each object is associated with a marker;
determining that the one or more objects are associated with a reward offer based on the marker via a computing device processor; and
presenting one or more indicators, each indicator being associated with the reward offer.

2. The method of claim 1, further comprising:
presenting an option associated with the reward offer; and
receiving and executing a command associated with the option.

3. The method of claim 2, further comprising:
issuing a reward.

4. The method of claim 2, further comprising:
presenting a website associated with the reward offer.

5. The method of claim 1, wherein the one or more objects comprise a building associated with a business location.

6. The method of claim 1, wherein the one or more objects comprise a product.

7. The method of claim 1, wherein the indicator comprises one of a visual indicator, auditory indicator, tactile indicator, or a combination thereof.

8. The method of claim 1, wherein the reward comprises one or more points.

9. The method of claim 1, further comprising:
determining the location of the one or more objects based on the marker via a computing device processor.

10. The method of claim 1, further comprising:
identifying, via a computing device processor, the one or more objected based on the marker.

11. The method of claim 1, wherein the marker comprises data selected from the group consisting of: a logo, a product identification number, a product feature, a sound associated with a product, a sound associated with a service, a sound associated with a business, user information, commercial characters, spokespersons, and combinations thereof.

12. A method for providing reward offer information in a real-time video stream, the method comprising:
receiving, at a server, information from a user using a mobile device, wherein the information is associated with an object captured in a real-time video stream by the mobile device, the object being associated with a reward offer;
analyzing the information based on financial transaction data associated with the user via a computing device processor; and
issuing a reward to the user.

13. The method of claim 12, further comprising:
processing a financial transaction related to the reward offer.

14. The method of claim 12, further comprising:
transmitting a communication related to the reward offer to the user, wherein the communication comprises one of a time period of the reward offer, terms of the reward offer, related reward offers, businesses associated with the reward offer, products related to the reward offer, rewards accumulated over a period of time, or combinations thereof.

15. The method of claim 12, further comprising:
issuing a second reward offer to the user.

16. The method of claim 12, wherein the information comprises at least one marker selected from the group consisting of: alpha-numeric characters, symbols, logos, shapes, ratio of size of one feature to another feature, a bar code, radio frequency identification (RFID), architectural features, color, or combinations thereof.

17. The method of claim 16, further comprising:
identifying the reward offer based on the at least one marker.

18. The method of claim 12, wherein the real-time video stream comprises one of video footage, screen shots, stills, auditory elements, or combinations thereof.

19. The method of claim 12, further comprising:
communicating instructions to the mobile device to present the reward offer to the user.

20. The method of claim 12, wherein the finance transaction data comprises one of a purchase price, a business where a purchase was made, product information, a payment method, or combinations thereof.

21. The method of claim 12, further comprising:
issuing a reward automatically upon occurrence of a specific triggering event.

22. The method of claim 12, further comprising:
updating reward points in an account of the user based on the financial transaction data.

23. A computer program product, the computer program product comprising a computer-readable medium having computer-executable instructions for performing:
recognizing one or more objects captured in the real-time video stream via a computer device processor, wherein each object is associated with a marker;
determining that the one or more objects are associated with a reward offer based on the marker via a computing device processor; and
presenting one or more indicators, each indicator being associated with the reward offer.

24. The computer program product of claim 23, wherein the indicator comprises one of a virtual image, a vibration, a lighted display, a lighted key pad, a flash of light, a beep, a ring tone, a text message, an email, a voice message, or a combination thereof.

25. The computer program product of claim 23, wherein the indicator comprises one of an amount of the reward offer, an expiration date of the reward offer, a type of reward associated with the reward offer, total earned rewards, or combinations thereof.

26. The computer program product of claim 23, wherein the computer-executable instructions further perform:
presenting a first reward offer amount associated with a first object and a second reward offer amount associated with a second object to allow the user to compare the first and second objects.

27. The computer program product of claim 23, wherein the one or more object comprises one of business locations, logos, artwork, products, or combinations thereof.

28. The computer program product of claim 23, wherein the computer-executable instructions further perform:
identifying the one or more objects based on the marker.

29. The computer program product of claim 23, wherein the computer-executable instructions further perform:
identifying a location associated with the one or more objects based on geographical coordinates received from a user using a mobile device.

30. The computer program product of claim 23, wherein the computer-executable instructions further perform:
presenting a second reward offer.

31. The computer program product of claim 23, wherein the computer-executable instructions further perform:
processing financial transactions related to the reward offer.

32. A system for providing reward offer information in a real-time video stream comprising:
a computer apparatus including a processor and a memory; and
a reward offer software module stored in the memory, comprising executable instructions that when executed by the processor cause the processor to:
recognize one or more objects captured in the real-time video stream wherein each object is associated with a marker;
determine that the one or more objects are associated with a reward offer based on the marker; and
present one or more indicators, each indicator being associated with the reward offer.

33. The system of claim 32, wherein the executable instructions further cause the process to:
present a first reward offer amount associated with a first object and a second reward offer amount associated with a second object to allow the user to compare the first and second objects.

34. The system of claim 32, wherein the executable instructions further cause the process to:
present options related to the reward offer in response to a user selecting the one or more indicators.

35. The system of claim 32, wherein the executable instructions further cause the processor to:
identify the one or more objects based on an environment associated with the one or more objects, the environment comprising one of visual surroundings, auditory surroundings, or combinations thereof.

36. The system of claim 32, wherein the marker is positioned on a product or a building.

37. The system of claim 32, wherein the executable instructions further cause the processor to:
receive financial transaction data from a user;
analyze the financial transaction data; and
identify a second reward offer based on the financial transaction data.

38. The system of claim 32, wherein the executable instructions further cause the processor to:
determine a location associated with the one or more objects based on the marker; and
present a second reward offer in the location associated with the one or more objects.
